(19) United States
(12) Patent Application Publication
(10) Pub. No.: US 2026/0125319 A1
(43) Pub. Date: May 7, 2026

(54) NEGATIVE CARBON GEOPOLYMER SLURRY, NEGATIVE CARBON GEOPOLYMER AND PREPARATION METHODS THEREOF

(71) Applicant: Metal Industries Research & Development Centre, Kaohsiung (TW)

(72) Inventors: Pei-Tung Shih, Kaohsiung (TW); Hao-De Lo, Kaohsiung (TW); Jia-Syun Li, Kaohsiung (TW); Ta-Wui Cheng, Taipei (TW); Wei-Hao Lee, Taipei (TW); Chia-Ho Wu, Taipei (TW); De-Wei Gao, Taipei (TW); Wen-Chieh Wu, Kaohsiung (TW); Kuang-Sheng Hong, Kaohsiung (TW); Yu-Chia Wei, Kaohsiung (TW)

(21) Appl. No.: 18/977,337

(22) Filed: Dec. 11, 2024

(30) Foreign Application Priority Data
Nov. 1, 2024 (TW) 113141960

(51) Int. Cl. C04B 12/00; C04B 111/00

(52) U.S. Cl. CPC C04B 12/005; C04B 2111/00017

(57) ABSTRACT

The present application discloses a negative carbon geopolymer slurry, a negative carbon geopolymer and preparation methods thereof. After introducing a carbon dioxide gas into a hydroxide solution, the geopolymer slurry is prepared (sequentially mixed with a sodium silicate solution, fly ash and furnace stone powder are mixed) to form a negative carbon geopolymer slurry with carbon storage function. Moreover, the negative carbon geopolymer slurry formed by this preparation method not only has low preparation cost, but also the negative carbon geopolymer subsequently prepared has certain economic value.

### FIELD OF THE INVENTION

The present application relates to a type of slurry and polymer and preparation methods thereof, specifically a negative carbon geopolymer slurry and negative carbon geopolymer that can sequester carbon dioxide and possess certain economic value.

### BACKGROUND OF THE INVENTION

Greenhouse gas emissions from human activities have intensified the greenhouse effect, leading to climate change. The carbon dioxide (CO₂) produced from burning fossil fuels such as coal, oil, and natural gas is one of the most significant contributors to climate change.

Hydrocarbons such as crude oil, coal, and natural gas extracted from the earth are processed into various oils, fuels, plastic rubber products, and organic chemicals. These hydrocarbon products, after combustion, produce power and heat, or become waste that is incinerated, ultimately releasing CO₂ into the atmosphere and increasing the environmental burden.

Currently, the International Energy Agency (IEA) (2020) has released an energy technology outlook report stating that renewable energy generation, bioenergy, hydrogen energy, and Carbon Capture, Utilization, and Storage (CCUS) are key technologies for achieving global net-zero emissions. Among these, CCUS is the only technology that can directly reduce or eliminate CO₂ emissions, balancing unavoidable emissions and playing a crucial role in achieving net-zero targets.

CCUS refers to the technology of collecting carbon dioxide produced from fuel combustion or industrial processes, transported by ships or pipelines, and permanently stored in deep geological structures underground, or used to create valuable products.

Among them, carbon capture and storage (CCS) refers to a process-separating relatively pure carbon dioxide (CO₂) produced by industry (such as from burning fossil fuels or biomass), processing it, and then transporting it to certain locations for long-term storage.

Typically, such carbon dioxide is captured from large point sources (such as chemical plants or biomass plants), processed, and then stored in deep geological structures. The purpose of this is to reduce greenhouse gas emissions into the atmosphere, thereby mitigating climate change.

Carbon Capture and Utilization (CCU) is the process of capturing carbon dioxide for further use. Carbon capture and utilization can address global challenges, namely significantly reducing greenhouse gas emissions from major fixed industrial emitters.

CCU differs from carbon capture and storage (CCS) because CCU does not lead to the permanent geological storage of carbon dioxide. Instead, the purpose of CCU is to convert captured carbon dioxide into more valuable substances or products.

However, current carbon storage technologies are high-cost storage technologies. Although carbon dioxide is stored, it is still unknown whether existing carbon storage technologies can continue given the costs involved.

Therefore, finding effective, low-cost, and highly utilizable carbon storage methods to store carbon dioxide is a problem that technicians in this field want to solve.

### SUMMARY OF THE INVENTION

A main objective of the present application is to provide a negative carbon geopolymer slurry, negative carbon geopolymer, and preparation methods thereof, by encapsulating carbon dioxide into a hydroxide solution, then preparing the geopolymer slurry (mixed sequentially with sodium silicate solution, fly ash, and slag powder), forming a negative carbon geopolymer slurry with carbon storage function.

To achieve above objective, the present application provides a preparation method for negative carbon geopolymer slurry, firstly introducing carbon dioxide gas into a hydroxide solution (which is a sodium hydroxide solution or a potassium hydroxide solution, molar concentration is from 3M to 6M) and stirring the hydroxide solution with the carbon dioxide gas (wherein the time of stirring is from 30 seconds to 2 minutes) at a room temperature and an atmospheric pressure to form a mixed solution, then adding a sodium silicate solution to the mixed solution and stir at the room temperature and the atmospheric pressure to form a negative carbon alkaline solution; and adding a powder material to the negative carbon alkaline solution and mix to form a negative carbon geopolymer slurry.

The present application further provides an embodiment, wherein in the step of introducing carbon dioxide gas into a hydroxide solution, a ventilation volume of the carbon dioxide gas is from 3 L/minute to 5 L/minute of the carbon dioxide gas, and a ventilation time of the carbon dioxide gas is from 1 minute to 5 minutes.

The present application further provides an embodiment, wherein in the step of adding a sodium silicate solution to the mixed solution and stirring at a room temperature and an atmospheric pressure, the content of sodium silicate powder in the 100 wt % sodium silicate solution ranges from 10 wt % to 50 wt %.

The present application further provides an embodiment, wherein in the step of adding a powder material to the negative carbon alkaline solution and mixing, the powder material includes fly ash and slag powder, and the weight ratio of the fly ash to the slag powder is between 1:1 and 7:3.

The present application further provides a negative carbon geopolymer slurry, which is prepared by following preparation method, firstly introducing carbon dioxide gas into a hydroxide solution (which is a sodium hydroxide solution or a potassium hydroxide solution, molar concentration is from 3M to 6M) and stirring the hydroxide solution with the carbon dioxide gas (wherein the time of stirring is from 30 seconds to 2 minutes) at a room temperature and an atmospheric pressure to form a mixed solution, then adding a sodium silicate solution to the mixed solution and stirring at the room temperature and the atmospheric pressure to form a negative carbon alkaline solution; and adding a powder material to the negative carbon alkaline solution and mix to form the negative carbon geopolymer slurry.

Further, the present application further provides a negative carbon geopolymer prepared by the negative carbon geopolymer slurry, a preparation method thereof as following, firstly providing a negative carbon geopolymer slurry as described in claim firstly introducing carbon dioxide gas into a hydroxide solution (which is a sodium hydroxide solution or a potassium hydroxide solution, molar concentration is from 3M to 6M) and stirring the hydroxide solution with the carbon dioxide gas (wherein the time of stirring is from 30 seconds to 2 minutes) at a room temperature and an atmospheric pressure to form a mixed solution, then adding a sodium silicate solution to the mixed solution and stirring at the room temperature and the atmospheric pressure to form a negative carbon alkaline solution; and adding a powder material to the negative carbon alkaline solution and mix to form a negative carbon geopolymer slurry; and pouring the negative carbon geopolymer slurry into a mold and proceeding a curing sequestration process at a room temperature, for forming the negative carbon geopolymer.

The present application further provides an embodiment, wherein in the step of introducing carbon dioxide gas into a hydroxide solution, a ventilation volume of the carbon dioxide gas is from 3 L/minute to 5 L/minute of the carbon dioxide gas, and a ventilation time of the carbon dioxide gas is from 1 minute to 5 minutes.

The present application further provides an embodiment, wherein in the step of adding a sodium silicate solution to the mixed solution and stirring at a room temperature and an atmospheric pressure, the content of sodium silicate powder in the 100 wt % sodium silicate solution ranges from 10 wt % to 50 wt %.

The present application further provides an embodiment, wherein in the step of adding a powder material to the negative carbon alkaline solution and mixing, the powder material includes fly ash and slag powder, and the weight ratio of the fly ash to the slag powder is between 1:1 and 7:3.

The present application further provides a negative carbon geopolymer, which is prepared by the preparation method of the negative carbon geopolymer according to the present application.

### BRIEF DESCRIPTION OF DRAWINGS

FIG. 1 which is a flowchart of the steps for the negative carbon geopolymer slurry according to the present application; and

FIG. 2 which is a flowchart of the steps for the negative carbon geopolymer according to the present application.

### DETAILED DESCRIPTION OF THE INVENTION

In order to allow the review committee to have a deeper understanding and recognition of the characteristics of the present application and the effects achieved, the following is a detailed description in combination with the embodiments and descriptions:

In view of the high cost of existing carbon sequestration technology and the imperative development of carbon sequestration, the present application therefore proposes a carbon-negative geopolymer slurry and a preparation method thereof to solve the problems caused by the known technology.

The following will further describe a method for preparing a carbon-negative geopolymer slurry of the present application, including its characteristics, supporting structure and method:

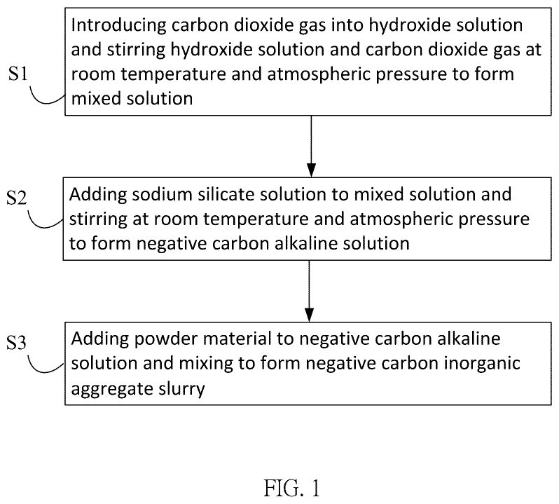

Please refer to FIG. 1, which is a flowchart of the steps for the negative carbon geopolymer slurry of the present application. As shown in the figure, the preparation method for the negative carbon geopolymer slurry according to the present application includes the following steps:
Step S1: Introducing carbon dioxide gas into hydroxide solution and stirring hydroxide solution and carbon dioxide gas at room temperature and atmospheric pressure to form mixed solution;
Step S2: Adding sodium silicate solution to mixed solution and stirring at room temperature and atmospheric pressure to form negative carbon alkaline solution; and
Step S3: Adding powder material to negative carbon alkaline solution and mixing to form negative carbon geopolymer slurry.

As shown in Step S1, a carbon dioxide gas is introduced into a hydroxide solution (which is a sodium hydroxide solution or a potassium hydroxide solution) and the hydroxide solution and carbon dioxide gas are stirred at a room temperature and an atmospheric pressure (stirring time can range from 30 seconds to 2 minutes) to form a mixed solution. In Step S1, the introducing of the carbon dioxide gas and the stirring of the hydroxide solution can be performed simultaneously, or the carbon dioxide gas can be introduced first and continued by stirring with the sodium hydroxide solution, as needed. In some embodiments, the stirring time for the hydroxide solution and the carbon dioxide gas can be, for example, 1 minute.

In practice, the room temperature mentioned in the present application can be, for example, 20° C. to 30° C., and the atmospheric pressure can be, for example, 1 atm. Understandably, the room temperature and atmospheric pressure conditions mentioned in the present application refer to the preparation method of the negative carbon geopolymer slurry, where there is no need to adjust the process temperature or control the environmental pressure additionally, thus no extra energy is consumed to adjust the environmental temperature and an atmospheric pressure (i.e., no additional carbon dioxide is produced under the process temperature and an atmospheric pressure).

For example, in the present application, the ventilation amount of carbon dioxide gas is from a 99% carbon dioxide gas cylinder, introducing 3 L˜5 L per minute into the hydroxide solution (preferably without splashing of the hydroxide solution), and the ventilation time of carbon dioxide gas can range from 1 to 5 minutes. In other examples, the ventilation time for the carbon dioxide gas can be 1 minute. Furthermore, in the present application, the hydroxide solution is exemplified by a sodium hydroxide solution, with a ratio of about 120 g˜240 g of sodium hydroxide powder added to 1000 milliliters of water, thus the molar concentration ranges from 3M to 6M.

Continuing, as shown in step S2, a sodium silicate solution (with 10 wt % to 50 wt % sodium silicate powder content) is added to the mixed solution and stirred at room temperature and an atmospheric pressure (stirring time from 30 seconds to 2 minutes) to form a negative carbon alkaline solution. In some examples, the stirring time for adding the sodium silicate solution to the mixed solution is 1 minute. In some examples, the amount of sodium silicate solution added is between 10 wt % and 50 wt % of the total weight of the powder material (such as fly ash and slag powder) in step S3.

The content of sodium silicate in the sodium silicate solution is directly proportional to the compressive strength of the negative carbon geopolymer slurry, which ranges from 7.5 million pascals (MPa) to 35 MPa.

Finally, as shown in step S3, a powder material is added to the negative carbon alkaline solution and mixed (also at room temperature and an atmospheric pressure) to form a negative carbon geopolymer slurry.

For instance, the powder material includes a type of fly ash and a type of slag powder, with a weight ratio ranging from 1:1 to 7:3. The fly ash is a gray powder with a particle size (D50) of 21.80 μm, primary compound comprising SiO₂, and Al₂O₃, as shown in Table 1 below:

TABLE 1
Chemical Composition of Fly Ash

| Composition | SiO₂ | Al₂O₃ | Fe₂O₃ | CaO | Others | L.O.I. |
|---|---|---|---|---|---|---|
| wt % | 60.2 | 19.1 | 8.7 | 2.7 | 6.4 | 2.9 |

*L.O.I. is ignition loss

The slag powder is a white powder with a particle size (D50) of 10.82 μm, primary compound comprising CaO, SiO₂, and Al₂O₃, as shown in Table 2 below:

TABLE 2
Chemical Composition of Slag Powder

| Composition | CaO | SiO₂ | Al₂O₃ | Fe₂O₃ | MgO | Others | L.O.I. |
|---|---|---|---|---|---|---|---|
| wt % | 40.2 | 34.7 | 14.1 | 0.2 | 7.1 | 3.7 | N.D. |

*L.O.I. is ignition loss/ N.D. is content less than 0.1%.

In other examples, the powder material may also selectively include other powder materials. It is understood that the fly ash and slag powder in the present application are not limited to the previously mentioned particle size (D50). In other embodiments, a person of ordinary skill in the art can select fly ash and slag powder with different particle sizes (D50) as needed.

In the present application, the mixing weight ratio of the negative carbon geopolymer slurry (the ratio of the total weight of liquid substances to the total weight of solid substances (liquid/solid ratio)) ranges from 0.4 to 0.8, where the liquid substances include the solvent of the sodium silicate solution and the solvent in the mixed solution, and the solid substances are the fly ash, the slag powder, and the solute of the mixed solution (when the hydroxide solution is a sodium hydroxide solution, the solute of the mixed solution includes sodium carbonate or sodium bicarbonate formed by the reaction of carbon dioxide gas with sodium hydroxide).

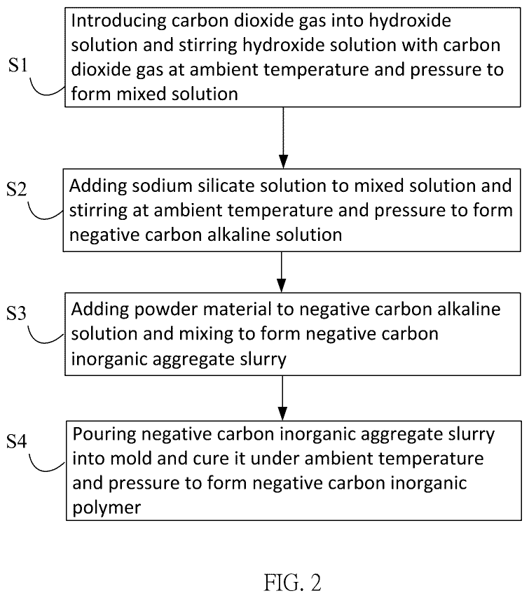

Furthermore, please refer to FIG. 2, which is a flowchart of the steps for the negative carbon geopolymer according to the present application. As shown in the figure, the preparation method of the negative carbon geopolymer according to the present application includes the following steps:
Step S1: Introducing carbon dioxide gas into hydroxide solution and stirring hydroxide solution with carbon dioxide gas at ambient temperature and an atmospheric pressure to form mixed solution;
Step S2: Adding sodium silicate solution to mixed solution and stirring at ambient temperature and an atmospheric pressure to form negative carbon alkaline solution;
Step S3: Adding powder material to negative carbon alkaline solution and mixing to form negative carbon geopolymer slurry;
Step S4: Pouring negative carbon geopolymer slurry into mold and cure it under ambient temperature and an atmospheric pressure to form negative carbon geopolymer.

A negative carbon geopolymer according to the present application is prepared from the negative carbon geopolymer slurry, thus the present application may be continued from Step S3, and further includes Step S4, where the negative carbon geopolymer slurry is poured into a mold (the size of which is not limited in the present application, and can be, for example, cylindrical (e.g., 10 cm to 50 cm in height, 5 cm to 20 cm in diameter, etc.), bar-shaped, etc.), and undergo a curing sequestration process at ambient temperature and an atmospheric pressure (the curing sequestration days range from 3 to 28 days), to form the negative carbon geopolymer.

Following is an embodiment of the present application (which involves the preparation of the negative carbon geopolymer):

Introduce the carbon dioxide gas (aeration time of 1 minute) into a 6M hydroxide solution, and stir (for 1 minute) at the room temperature and the atmospheric pressure to mix the hydroxide solution with the carbon dioxide gas, forming a mixed solution. Continue to add sodium silicate solution (to form a molar ratio of 1.28 SiO₂/Na₂O) and stir (for 1 minute) at the room temperature and the atmospheric pressure to form the negative carbon alkaline solution. Subsequently, add 50 wt % fly ash and 50 wt % slag powder at a 1:1 weight ratio into the negative carbon alkaline solution and mix (for about 3 minutes) to form the negative carbon geopolymer slurry.

Continue by pouring the negative carbon geopolymer slurry into a mold (diameter 15 cm×height 10 cm), and cure it under room temperature and atmospheric pressure (the curing period can be either 7 days or 28 days, depending on subsequent testing conditions). After demolding, the negative carbon geopolymer is formed.

Subsequently, after curing at room temperature for about 7 days and 28 days, the carbon fixation rate and compressive strength of the negative carbon geopolymer are tested. The compressive strength test of the present application is conducted according to the [CNS 1232 Concrete Cylinder Compressive Strength Test Method]; each test group involves testing three specimens (from the negative carbon geopolymer), and the results are averaged.

The results of its compressive strength are shown in Table 3, compared with the conventional geopolymers produced by conventional processes. In the conventional process, 50 wt % fly ash and 50 wt % slag powder are first mixed at a 1:1 weight ratio for 30 seconds, then an alkaline solution (a mixture of 6M sodium hydroxide solution and sodium silicate solution forming a molar ratio of 1.28 SiO₂/Na₂O) is added, followed by the addition of sodium aluminate solution (50 molar ratio of SiO₂/Al₂O₃) and mixed (for about 3 minutes) to form a geopolymer slurry. Continue by pouring it into a mold (diameter 15 cm×height 10 cm) and cure under room temperature and atmospheric pressure (the curing period can be either 7 days or 28 days, depending on subsequent testing conditions), to form a conventional geopolymer after demolding.

TABLE 3
table of compression strength

| | Compression strength (Mpa) | |
|---|---|---|
| | 7 Days | |
| | | Standard |
| Process Type | Value | Deviation |
| Normal Process | 76.24 | 2.60 |
| Negative carbon geopolymer process | 83.4 | 0.24 |
| according to the present application | | |

As shown in Table 3, the preparation method of the negative carbon geopolymer according to the present application can indeed maintain a certain compression strength (MPa), and is significantly higher than that of the conventional processes.

The carbon fixation rate test of the present application is conducted on specimens after compressive strength testing (crushed to below 4 mesh size), and the testing process is as follows: After the specimen is crushed, it is weighed (M0), then placed in a 105° C. oven for 24 hours of drying, removed and weighed after cooling, the weight loss during this process is defined as the interlayer water content; subsequently, the same batch of specimens is placed in a high-temperature furnace, heated to 450° C., maintained for 1 hour, removed and weighed after cooling (M1), the weight loss in this process is defined as the crystalline water content; finally, the same batch of specimens is again placed in a high-temperature furnace, heated to 900° C., maintained for 1 hour, removed and weighed after cooling (M2), the weight loss in this process is defined as the thermal decomposition of calcium carbonate (CaCO₃) in the material, which is the carbon fixation rate, and the calculation method of the carbon fixation ratio is as follows:

$$Carbon Fixation Ratio ( wt . \% ) = ( M 1 - M 2 ) / M 0 \times 100 \%$$

The results of the carbon fixation rate of the negative carbon geopolymer of the present application are shown in Table 4.

TABLE 4
Carbon Fixation Ratio Table

| | Carbon Fixation Ratio Table (wt. %) | | | | | |
|---|---|---|---|---|---|---|
| | 7 days | | | 28 days | | |
| | interlayer | crystalline | | interlayer | crystalline | |
| Process Type | water | water | CaCO₃ | water | water | CaCO₃ |
| Negative | 19.28 | 5.25 | 3.97 | 15.22 | 9.26 | 3.99 |
| carbon | | | | | | |
| geopolymer | | | | | | |
| process | | | | | | |
| according to | | | | | | |
| the present | | | | | | |
| application | | | | | | |

As shown in Table 4, compared to after 7 days of room temperature curing, the negative carbon geopolymer of the present application after 28 days of curing still has a similar carbon fixation rate, demonstrating the stable carbon fixation effect of the present application's negative carbon geopolymer, where the slight increase in CaCO₃ is deduced to be due to the continuous absorption of CO₂ from the environment during the curing process.

From the above examples, it is evident that the preparation method of pre-introducing carbon dioxide into an alkaline solution in the present application indeed has a carbon fixation effect, and besides carbon fixation, it maintains a certain compressive strength, demonstrating that the negative carbon geopolymer slurry/negative carbon geopolymer of the present application, besides being environmentally friendly (carbon fixation), still has high economic value and can also be made into products similar to cement.

1. A preparation method for negative carbon geopolymer slurry, comprising the steps of:
introducing a carbon dioxide gas into a hydroxide solution and stirring the hydroxide solution with the carbon dioxide gas at a room temperature and an atmospheric pressure to form a mixed solution;
adding a sodium silicate solution to the mixed solution and stirring at the room temperature and the atmospheric pressure to form a negative carbon alkaline solution; and
adding a powder material to the negative carbon alkaline solution and mixing to form a negative carbon geopolymer slurry.

2. The preparation method of the negative carbon geopolymer slurry as claimed in claim 1, wherein in the step of introducing a carbon dioxide gas into a hydroxide solution, the hydroxide solution is either a sodium hydroxide solution or a potassium hydroxide solution.

3. The preparation method of the negative carbon geopolymer slurry as claimed in claim 1, wherein a molar concentration of the hydroxide solution ranges from 3M to 6M.

4. The preparation method of the negative carbon geopolymer slurry as claimed in claim 1, wherein in the step of stirring the hydroxide solution with the carbon dioxide gas at a room temperature and an atmospheric pressure to form a mixed solution, the stirring time is between 30 seconds and 2 minutes.

5. The preparation method of the negative carbon geopolymer slurry as claimed in claim 1, wherein in the step of adding a sodium silicate solution to the mixed solution and stirring at a room temperature and an atmospheric pressure, the content of sodium silicate powder in the 100 wt % sodium silicate solution ranges from 10 wt % to 50 wt %.

6. The preparation method of the negative carbon geopolymer slurry as claimed in claim 1, wherein in the step of adding a sodium silicate solution to the mixed solution and stirring at a room temperature and an atmospheric pressure, the stirring time is between 30 seconds and 2 minutes.

7. The preparation method of the negative carbon geopolymer slurry as claimed in claim 1, wherein in the step of adding a powder material to the negative carbon alkaline solution and mixing, the powder material includes fly ash and slag powder, and the weight ratio of the fly ash to the slag powder is between 1:1 and 7:3.

8. A negative carbon geopolymer slurry, which is prepared by the preparation method as claimed in claim 1.

9. A preparation method of a negative carbon geopolymer, comprising the steps of:
providing a negative carbon geopolymer slurry as described in claim 8; and
pouring the negative carbon geopolymer slurry into a mold and proceeding a curing sequestration process at a room temperature, for forming a negative carbon geopolymer.

10. A negative carbon geopolymer, which is prepared by a preparation method of claim 9.
